(19) United States
(12) Patent Application Publication
(10) Pub. No.: US 2009/0074910 A1
(43) Pub. Date: Mar. 19, 2009

(54) CHEWING GUM FOR PREVENTING TOOTH DECAY

(75) Inventors: Doron Steinberg, Jerusalem (IL); Shlomo Magdassi, Jerusalem (IL); Alexander Kamyshny, Jerusalem (IL); Haim Zegerman, Ramat-Gan (IL); Arie Letzter, Kiryat-Tivon (IL)

Correspondence Address: MARTIN D. MOYNIHAN d/b/a PRTSI, INC., P.O. BOX 16446, ARLINGTON, VA, 22215, US

(73) Assignees: Strauss Group Ltd., Ramat-Gan (IL); Yissum Research Development Company of the Hebrew University of Je, Jeruslem (IL)

(21) Appl. No.: 11/884,791

(22) PCT Filed: Feb. 22, 2006
(86) PCT No.: PCT/IL2006/000235

§ 371 Date: Oct. 14, 2008

(30) Foreign Application Priority Data
Feb. 22, 2005 (IL) 167052

(51) Int. Cl. A23G 4/06

(52) U.S. Cl. 426/3

(57) ABSTRACT

Disclosed are chewing gums that are organoleptically acceptable, and have high adherence to plaque bacteria. A chewing gum according to an exemplary embodiment contains a gum base, at least one edible acid, and optionally other ingredients. The invention also provides a method for preparing a chewing gum composition, which includes triturating of coloring agent, and a method for commercially producing and marketing chewing gums, which includes testing the chewing gums for adhesion to bacteria, such as plaque bacteria.

### FIELD OF THE INVENTION

This invention relates to chewing gums that have dental benefits, for example, to chewing gums that adhere to dental biofilm.

### BACKGROUND OF THE INVENTION

It is well known in the art that deterioration and demineralization of teeth material may be enhanced due to pH drop in the oral cavity, especially after eating. This effect may be reduced by chewing a chewing gum, since the chewing causes the mouth to produce more saliva and secrete pH regulating agents that fastens the raise of the pH in the mouth.

Besides this well known effect of all chewing gums, it was suggested in the literature to add to chewing gums anti-bacterial agents (e.g. U.S. Pat. No. 6,248,309, the disclosure of which is incorporated herein by reference), immuno-modulators (JP 05262629, the disclosure of which is incorporated herein by reference), and other dental-beneficial substances.

WO 03/059302 suggests introducing into edible and/or chewable articles of manufacture a food grade substance having adsorption affinity towards a dental plaque constituent. This publication, incorporated herein by reference, also explains why this may be of particular dental benefit.

It is an object of some embodiments of the present invention to provide novel chewing gum compositions that dental plaque bacteria adhere thereto.

### SUMMARY OF THE INVENTION

Biofilms of bacteria immobilized to teeth surfaces are highly associated with dental diseases and disorders. Removing these immobilized bacteria from their habitat is a significant step in minimizing their effect. In exemplary embodiments of the invention, biofilm is partially or wholly removed by adhering to a chewing gum. Without being bound to theory, the adherence of bacteria to the chewing gum depends mainly on electrostatic and/or hydrophilic/hydrophobic interactions between the outer surface of the chewing gum and the bacteria.

According to a first aspect of the present invention there is provided a chewing gum with enhanced adhesion to plaque bacteria. Optionally, the adhesion is enhanced by an adhesion enhancing additive. Additionally or alternatively, the adhesion is enhanced by excluding from the composition of the chewing gum additives that reduce the adhesion.

An adhesion enhancing additive is an additive, the addition of which to a chewing gum composition results in the composition having higher adhesion affinity level, in comparison to the composition without the agent. The increase in the adhesion affinity level is optionally at least 100 CPM, at least 1.000 CPM, at least 2000 CPM or any higher, lower or intermediate value. A certain substance may be an adhesion enhancing additive when added to one composition and not be an adhesion enhancing agent when added to another composition.

The adhesion enhancing additive is preferably present in an effective amount, that is, an amount that is sufficient for increasing the adhesion affinity level. An amount of a substance is effective depending on the substance and optionally also on other ingredients of the gum base.

In an exemplary embodiment of the invention, a chewing gum comprises a gum base and at least one edible carboxylic acid, such as malic acid or citric acid. Optionally, the weight ratio between all edible acids and gum base causes the chewing gum to exhibit high adhesion affinity level, as this is defined below.

Examples to high values of adhesion affinity level are 3000 CPM, 4000 CPM, and 6000 CPM.

Preferably, a chewing gum according to the invention exhibits acceptable organoleptic characteristics.

Preferably, the chewing gum is sugarless (i.e. without sucrose) and includes polyols, such as sorbitol, xylitol, maltitol, or isomaltitol.

Preferably the chewing gum is free of un-kosher ingredients, such as chitosan.

In the present description and claims, the term adhesion affinity level refers to the amount of bacteria adhered to the chewing gum under controlled conditions, and is measured as radioactivity reading in a scintillation counter in a procedure that is described in detail in the section of this specification titled “detailed description of the invention”. Generally, a piece of chewing gum is immersed in a solution of pre-radioactively labeled bacteria. Afterwards, the chewing gum is taken out of the solution, rinsed, dried, and its radioactivity is measured by a scintillation counter. The readings thus obtained are referred herein as adhesion affinity level.

Alternatively or additionally, other assays capable of indicating the amount of bacteria adhered to the chewing gum is used for measuring adhesion affinity level. Non-limiting examples of those are assays including bacteria that carry other labels, such as antibodies attached to the bacteria, fluorescence marked bacteria, etc.

Six different commercially available chewing gums marketed in Israel under the tradename of Orbit were checked for adhesion affinity levels, and all were found to have a level of less than 500 CPM (see FIG. 1). These were Orbit peppermint, Orbit winterfresh, Orbit spearmint, Orbit tropical, Orbit berries, and Orbit classic. The last three are with calcium, added as calcium lactate.

Acceptable organoleptic characteristic of chewing gums are known in the art, and relate to variables such as taste, flexibility, stickiness, elasticity, texture and the like, which makes an edible product acceptable to a broad audience. Organoleptic acceptability is checked with focus groups, the members of which are requested to evaluate the quality of the product, generally, and/or in relation to one or more of the above-mentioned variables. In an embodiment of the invention, a chewing gum is organoleptically acceptable if it is considered by members of a focus group to be comparable in quality to a commercially available chewing gum. Here, comparable means better, equal, or inferior in no more than one quality unit on a scale of 4 or 5 units in each of the characteristics checked.

It was found by the inventors that adding edible acid(s) to many chewing gum compositions improves their adhesion affinity level. However, beyond a certain amount of acids, the chewing gum typically does not satisfy organoleptic requirements, usually due to over sourness. This specific amount depends on the specific acids used and on the other ingredients of the composition.

One way to produce a chewing gum in accordance with some embodiments of the invention is to check the adherence capacity and organoleptic properties of chewing gums of various compositions, and chose those that exhibit both sufficient adherence affinity level (for example, above 3000, 4000, or 6000 CPM) and acceptable organoleptic properties.

In many chewing gum compositions checked by the inventors, a weight/weight ratio between gum base and citric acid of at least 1.0 g acid to 60 g Gum base, was found to be associated with adhesion affinity levels of 3000 CPM or above. A ratio of less than 1.8:60 was found to be organoleptically acceptable. A satisfying balance between organoleptic acceptability and adhesion affinity level was found with a composition having a ratio of about 1.4:60. Applying similar considerations, in malic acid, a ratio between the acid and the gum base of from about 1.5:60 to about 1.8:60 was found to be preferable.

Non-limiting examples to other edible acids that may be considered adhesion enhancing agents, when used in effective amounts, are citric, fumaric, succinic, tartaric sulfuric and phosphoric acids. A composition according to embodiments of the invention optionally includes one or more edible acids, preferably non-volatile ones. Without being bound to theory, it is suggested that polycarboxylic edible acids, such as citric, fumaric, succinic, and tartaric acid, enhance adhesion between the chewing gum and the bacteria because of interaction between carboxylic groups and groups on the outer envelope of the bacteria.

In some cases, the absorption affinity level of a chewing gum composition that contains an edible acid may be improved by adding to the composition a salt of an edible acid. Such salt may be a salt of an edible acid that is included in the composition, as if to provide a buffer, but is not necessarily so. The salt is preferably insoluble in water, namely, its solubility is lower than 3 g/litr. Example of such a salt that showed increase in adherence affinity level, without compromising organoleptic effect is calcium citrate.

It was found that when artificial sweeteners, such as Acesulfame-K, and Aspartame, are used together the adhesion affinity level achieved is lower than when only one artificial sweetener is used. Compositions sweetened with Aspartame were found to have higher adhesion affinity level than similar compositions, sweetened to a similar degree with Acesulfame-K.

It was also found that coloring agents, for example, Carmoisine, lycopene, chlorophyll, and carotene, have a positive effect on the adherence of plaque bacteria to chewing gums. This effect was found with Carmoisine in when used in amounts of between 1 and 50 mg per 60 g gum base, and mostly when used in amounts of between 5 and 25 mg Carmoisine per 60 g gum base.

Flavoring agents were also found to affect the adhesion affinity of chewing gums, and most promising in this respect are fruit flavored chewing gums, such as cherry-, mango-peach-lemon- and tutti fruiti flavored chewing gums.

It was also found that sugar coating adversely affects the adherence of plaque bacteria to the chewing gums. Additionally, it is preferable to use only a minimal amount of talc and/or mannitol when manufacturing a chewing gum in accordance with some embodiments of the invention, and if omitting talc is possible—it is recommended.

Since homogeneous concentration of color is desirable by many consumers for aesthetic reasons, the application of carmoisine in small quantities as required by some embodiments of the invention, calls for special care to ensure that it is homogeneously distributed in the chewing gum composition

To deal with this issue, the present invention also provides a method for producing a chewing gum with small amounts of coloring agent evenly distributed throughout the chewing gum, the method comprising a step of triturating the coloring agent into the composition. Trituration may be carried out, for instance, by slowly mixing the coloring agent with a large quantity of polyol, until a homogeneous distribution of the color is achieved, and then mixing the homogeneous polyol-carmoisine mixture into a melt of the gum base. Other ingredients may then be added. In the case of carmoisine, the quantity of polyol mixed with the coloring agent is optionally at least 100 times, preferably about 250 times, the quantity of carmoisine.

The present invention also provides a method for commercially producing and marketing chewing gums, the method comprising:
producing a batch of chewing gums;
checking the extent at which bacteria, preferably plaque bacteria, adhere to at least one chewing gum from the batch; and
marketing the batch of chewing gums according to the results of said checking. The extent at which bacteria adhere to the selected chewing gum is checked in accordance with the invention by any assay known in the art for checking adherence of bacteria to surfaces. Optionally, radioactive assays are used.

For instance, a testing procedure was developed, the procedure comprising:
exposing labeled bacteria (for instance, radioactively labeled, optionally with thymidine) with the tested chewing gum;
optionally removing from the chewing gum loosely bound bacteria, for instance, by rinsing; and
determining the amount of markers that appear on the tested chewing gum.

One such procedure is described in more detail herein below as a procedure for determining adhesion affinity level. Thus, according to an exemplary embodiment of the invention, the chewing gum is tested for adhesion affinity level, and marketed as a gum that enhances adhesion of plaque bacteria only if the adhesion affinity level is above a predetermined level, optionally above 3000 CPM, above 4000 CPM, or above 6000 CPM.

Optionally, batches of chewing gums, wherein the selected chewing gum showed satisfying adherence to bacteria are marketed in one manner, and other batches are marketed differently. The various marketing manners may be expressed in selling the chewing gums in packaging of different appearance, under different trade names, with different writing on the packaging, and the like.

Accordingly, one aspect of the present invention relates to an organoleptically acceptable chewing gum, optionally a sugar-free one, which exhibits adhesion affinity level of at least 3000 CPM, optionally at least 4000 CPM. Optionally, the chewing gum comprises a gum base and an effective amount of at least one adhesion enhancing agent. Optionally, the adhesion enhancing agent comprises an edible acid. Additionally or alternatively, the adhesion enhancing agent comprises a salt of an edible acid, optionally a water-insoluble salt, such as calcium citrate. Additionally or alternatively, the adhesion enhancing agent comprises a coloring agent, optionally carmoisine. Alternatively or additionally, the adhesion enhancing agent includes a natural coloring agents, such as chlorophyll, carotene, lycopene, or combination thereof. Additionally or alternatively, an adhesion enhancing agent includes a flavor, such as tutti-fruiti, cold lemon, and mint.

Optionally, the weight/weight ratio between edible acids and the gum base is at least 0.8 g acid: 60 g gum base, optionally less than 1.8 g acid: 60 g gum base.

In some embodiments of the invention, the edible acid comprises at least one of citric, malic, fumaric, succinic, tartaric, sulfuric, and/or phosphoric acid.

In case of malic acid the gum:acid ratio is preferably between 60:1.5 and 60:1.8.

Optionally, the gum:calcium citrate ration is from 60:1.8 and 60:2.2.

In an embodiment of the invention, a chewing gum becomes organoleptically unacceptable if the amount of edible acids in it is raised by 25% or more.

In an exemplary embodiment of the invention, the chewing gum includes only one artificial sweetener.

Optional amounts of carmoisine as an adhesion enhancing agent are from 1 to 50 mg carmoisine per 60 g gum base, from 1 and 25 mg carmoisine per 60 g gum base, or about 6 mg per 60 g gum base.

In an exemplary embodiment of the invention the chewing gum is substantially free of talc or talc replacement. Substantially free of talc or talc replacements means containing the minimal amount of talc or talc replacement required to release the gum from the machine on which it is produced, and this is typically 3%.

A chewing gum according to an exemplary embodiments of the invention is free of non-kosher ingredients.

Optionally, a chewing gum according to an embodiment of the invention comprises gum base, polyols, calcium citrate, edible acid(s), fruit flavor, and carmoisine; and per 60 g gum base it includes 3-8 mg carmoisine and 1.6-2 g edible acid selected from citric acid, malic acid, and mixtures thereof.

An exemplary embodiment of the invention is a chewing gum comprising at least the following components: a gum base, at least one edible acid, and at least one of (i) salt of an edible acid and (ii) coloring agent, and the weight ratio between all these components being such that the chewing gum exhibits adhesion affinity level of at least 3000 CPM, optionally at least 4000 CPM, while having acceptable organoleptic characteristics.

An exemplary embodiment of the invention is an organoleptically acceptable sugar free chewing gum having an adhesion affinity level of above 3000 CPM, optionally above 4000 CPM, which is substantially free of at least one of the following: sugar coating, talc or its replacement, Acesulfam-K, and Aspartame.

An exemplary embodiment of the invention is an organoleptically acceptable chewing gum comprising a gum base and at least one edible non-volatile acid, the weight ratio between all edible acids and gum base being such that the chewing gum exhibits adhesion affinity level of at least 3000 CPM.

Another aspect of the present invention relates to a method for commercially producing and marketing chewing gums comprising: producing a batch of chewing gums; checking at least one chewing gum of said batch for the extent at which bacteria, for example, plaque bacteria, adhere to said at least one chewing gum; and marketing a batch of chewing gums responsive to the results of said checking.

Generally, an optional procedure for the checking includes providing bacteria which carry markers, for instance, radioactive markers; contacting the marked bacteria with the tested chewing gum or with a portion thereof; rinsing the contacted chewing gum; and determining the amount of markers that appear on the rinsed chewing gums.

Another aspect of the present invention relates to a method for preparing a chewing gum, comprising: melting gum base; mixing a coloring agent, for instance: Carmoisine, with polyol, in a ratio of at least 100 g, optionally with at least 250 g of polyol, such as sorbitol, per 1 g coloring agent to obtain a mixture with homogeneous color; and mixing the mixture obtained with the melt gum base.

### BRIEF DESCRIPTION OF THE DRAWINGS

Exemplary chewing gum compositions and their adhesion affinity levels will now be described, by way of non-limiting examples only, with reference to the accompanying drawings, in which:

FIG. 1 is a graph showing adhesion affinity levels of chewing gums according to some embodiments of the invention, commercially available chewing gums, and a negative control chewing gum; and

FIG. 2 is a graph showing adhesion affinity level of chewing gums according to several embodiments of the invention and a control.

### DETAILED DESCRIPTION OF THE INVENTION

To better understand the invention and to see how it may be carried out in practice, a detailed description of the procedure for measuring adhesive affinity level is given herein.
(a) cardiogenic bacteria, Streptococcus mutans ATCC 27351 were grown overnight on brain heart infusion at 37° C. in 5% CO₂ with ³H-Thymidine [NEN, USA];
(b) after incorporation of the Thymidine into the genome of the grown bacteria, the labeled bacteria were washed with 10 ml phosphate saline buffer in order to wash out the radioactive substrate;
(c) the bacterial suspension obtained this way was adjusted to give optical density of 1.3±0.1 OD at 540 nm;
(d) bacteria were sonicated for 10 minutes in a sonicator bath;
(e) chewing gum samples were cut to rectangles of 0.2×0.7 cm;
(f) 1 ml of the radio labeled bacteria suspension was added to the chewing gum rectangles;
(g) The chewing gums in the radio-labeled bacteria suspension were incubated at 37° C. for 15 min with agitation; and
(h) the incubated samples were washed three times with phosphate saline buffer, dried and placed in scintillation counter (Kontron, Switzerland). The reading of the scintillation counter thus produced are related herein as the adhesion affinity level, as they are interpreted to be indicative of the number of bacteria that attached to the chewing gum. 0.05 ml of the bacterial suspension prepared in (c) gave readings of between 10,000 and 11,000 CPM.

Positive control adhesion affinity levels were determined with hydroxyapatite beads. The reading of such beads, after being exposed to the bacterial solution and rinsed, was between 55,000 and 60,000 CPM.

Negative control adhesion affinity levels were determined with a chewing gum, which consisted of: Gum base—6 g, Syrup maltitol—2 g, Sorbitol—4 g, Xylitol—1 g, Glycerol—0.4 g. The readings of such chewing gums, after being exposed to the bacterial solution and rinsed, were in the range of 500±150 CPM.

Correlation between results obtained by this in vitro test and clinical trial were established. A clinical trial showed that chewing a gum according to the invention reduces the amount of plaque bacteria in the mouth much more than chewing a control, commercially available, chewing gum. The difference was statistically significant (p=0.003). Sharp decrease in the amount of bacteria in the saliva was observed in 43.9% of the participants that chewed a chewing gum according to the invention, while only 17.9% of the participants that chewed a control chewing gum showed comparable decrease in the amount of plaque bacteria. Chewing a gum according to the invention was also followed with increase of saliva amount in the mouth, compared with control chewing gum. Other physiologically important variables, including buffer capacity of the saliva, and saliva pH were also found to be influenced by chewing a gum of the invention more positively than by chewing a control, commercially available, gum.

In order to help a skilled person in producing compositions in accordance with some embodiments of the invention, detailed herein below are several compositions tested by the inventors, and their measured adhesive affinity levels.

### EXAMPLE 1

Gum base: 60 g, Syrup maltitol: 20 g, Sorbitol: 60 g, Xylitol: 10 g, Glycerol: 4 g, calcium citrate 2.08 g, Malic acid 1.8 g, carmoisine 6 mg, coated Aspartame 0.4 g, talc replacement (i.e. mixture of mannitol and talc in w/w ratio of 3:1): about 5 g, and cherry extract: 2 g. A chewing gum of this composition showed adhesive affinity level of 4400±500 CPM. Sugar coating decreased the adhesive affinity level of the same composition to 330±90 CPM.

Chewing gum according to this composition was found organoleptically satisfactory, and was tried clinically.

### EXAMPLES 2-4

Three chewing gums compositions were compared for adhesion affinity level. All the three compositions contained gum base: 60 g, syrup maltitol: 20 g, sorbitol: 40 g, xylitol: 10 g, glycerol: 4 g, citric acid: 2.8 g, calcium citrate: 2.08 g, and Tuti Fruiti extract: 2 g. The compositions also contained carmoisine lake in different amounts as follows: composition A: 1 mg, composition B: 6 mg and composition C: 25 mg. The respective adhesion affinity levels were: 3300±400 CPM, 4700±700 CPM, and 3700±1000 CPM.

### EXAMPLES 5-7

Three chewing gum compositions were prepared as in examples 2-4, but with 2 g of cold lemon extract instead of the 2 g Tuti Fruiti extract. The respective adhesion affinity levels were 4200±700, 5200±900, and 6200±900 CPM. These compositions were found to be more tasty than those of examples 2-4.

### EXAMPLES 8-11

Four chewing gum compositions were compared for adhesion affinity level.

All four compositions contained the following ingredients: gum base: 60 g, syrup maltitol: 20 g, xylitol: 10 g, sorbitol: 60 g, glycerol: 4 g, calcium citrate: 2.08 g, carmoisine: 6 mg, flavoring extract 2 g, talc replacement about 5 g, and artificial sweetener 0.4 g.

Other ingredients and adhesion affinity levels are summarized in the following table:

| | Citric | Malic | Kind of | | Adhesion |
|---|---|---|---|---|---|
| Sample | acid | Acid | flavor | Sweetener | affinity level |
| 8 | 0 | 1.8 g | Cherry | Asparame | 4600 ± 400 |
| 9 | 0.9 g | 0.9 g | Cherry | AsparameA | 4100 ± 500 |
| 10 | 0 | 1.8 g | Mango-peach | Acesulfame-K | 4300 ± 600 |
| 11 | 0.9 g | 0.9 | Mango-peach | Acesulfame-K | 4000 ± 400 |

### EXAMPLES 12-14

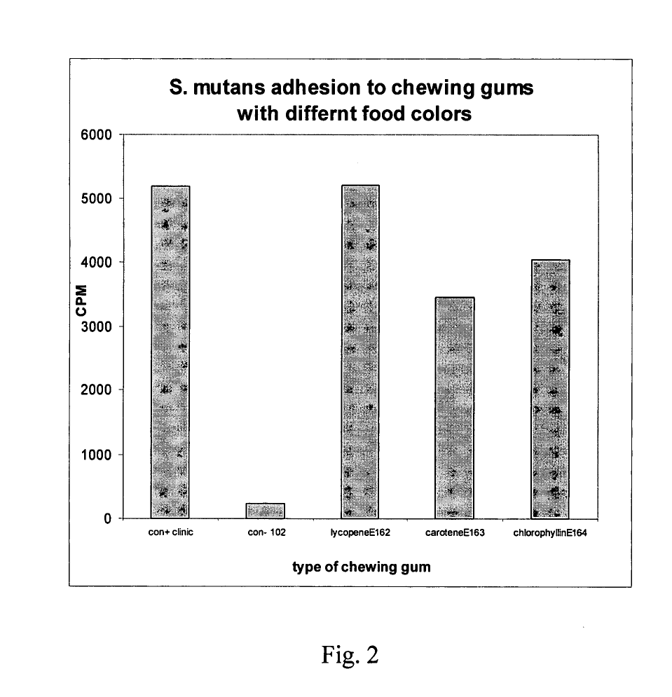

The adhesion affinity levels of three other chewing gums according to embodiments of the invention are provided in FIG. 2. Compositions and measured adhesion affinity levels of these chewing gums are shown in the following table:

| Example 12 | Example 13, | Example 14 | |
|---|---|---|---|
| 37.42 | 37.43 | 37.42 | gum base |
| 12.47 | 12.51 | 12.51 | syrup maltitol |
| 37.42 | 37.43 | 37.43 | sorbitol |
| 2.5 | 2.5 | 2.5 | glycerol |
| 3.23 | 3.23 | 6.23 | xylitoyl |
| 1.12 | 1.12 | 1.12 | malic acid |
| 1.29 | 1.29 | 1.29 | calcium citrate |
| 0.25 | 0.25 | 0.25 | coated Asparame |
| 1.24 | 1.24 | 1.24 | cherry extract |
| 0.00033% | — | — | chlorophyll |
| — | 0.00033% | — | carotene |
| — | — | 0.0166% | lycopen |
| 4000 CPM | 3200 CPM | 5400 CPM | adhesion affinity level |

As can be seen from the figure, the chewing gums according to examples 12, 13, and 14 all had adhesion affinity level of above 3,000.

### REFERENCE EXAMPLES

Several commercially available chewing gums were tested for adhesion affinity level and the following is a summary of the results obtained:

Orbit peppermint: A mint flavored sugarless chewing gum, which includes (as indicated on its label) sorbitol, gum base, stabilizer E422, mannitol, flavoring agents, Aspartame, emulsifier E322, Acesulfame-K, antioxidant E320.

Orbit winterfresh: sugarless chewing gum with mint flavor, which includes (as indicated on its label) sorbital, gum base, stabilizer E422, mannitol, syrup maltitol, flavoring agents, Acesulfame-K, Aspartame, antioxidant E320.

Orbit spearmint: sugarless mint flavored chewing gum, which includes (as indicated on its label) sorbital, gum base, mannitol, stabilizer E422, syrup maltitol, flavoring agents, Aspartame, emulsifier E322 and antioxidant E320.

Orbit tropical: sugarless fruit flavored chewing gum with calcium which includes (as indicated on its label) sorbital gum based xylitol, mannitol, flavoring agents, calcium lactate, stabilizer E422, citric acid, Acesulfame-K, Aspartame, emulsifier E322, antioxidant E320 and edible color E100.

Orbit berries: fruit flavored sugarless chewing gum with calcium which includes (as indicated on its label) sorbitol gum base, xylitol, mannitol, stabilizer E422, calcium lactate, flavoring agents, citric acid, Acesulfame-K, Aspartame, emulsifier E322, antioxidant E320, edible colors E129, brilliant blue PCP.

Orbit classic: fruit flavored sugarless chewing gum with calcium which include (as indicated on its label) sorbitol gum base, xylitol, mannitol, calcium lactate, stabilizer E422, flavoring agents, Acesulfame-K, Aspartame, antioxidant E320, red alurae E129.

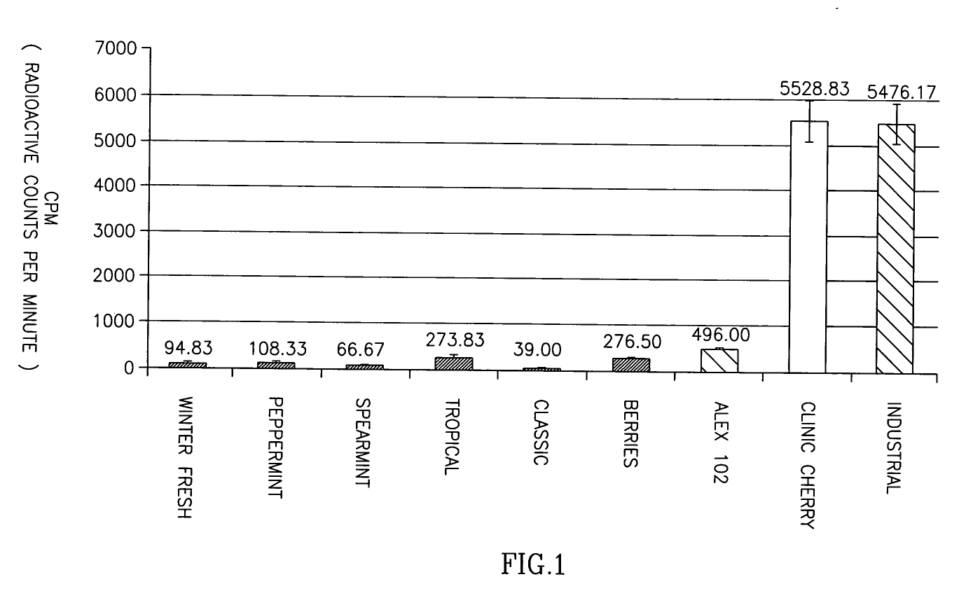

FIG. 1 summarizes the adhesion affinity levels of these chewing gums, and shows also the adhesion affinity levels of two batches of chewing gums according to example 1, named in the figure “clinic cherry” and “industrial”, and Alex 102 “negative control”. These numbers are summarized in the following table:

| Chewing gum | Adhesion affinity level |
|---|---|
| Orbit ™ Winterfresh | 94.83 |
| Orbit ™ Pepermint | 108.33 |
| Orbit ™ Spermint | 66.67 |
| Orbit ™ Tropical | 273.83 |
| Orbit ™ Classic | 39.00 |
| Orbit ™ Berries | 276.5 |
| Alex102 (negative control) | 496.00 |
| Clinic Cerry | 5528.83 |
| Industrial | 5476.17 |

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps described with respect to one of the embodiments. Variations of embodiments described will occur to persons of the art. Furthermore, the terms “comprise,” “include,” “have” and their conjugates, shall mean, when used in the disclosure and/or claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents, which perform the same function, even if the structure or acts are different, as known in the art. Therefore, the scope of the invention is limited only by the elements and limitations as used in the claims.

1. An organoleptically acceptable chewing gum, which exhibits adhesion affinity level of at least 3000 CPM.

2. An organoleptically acceptable chewing gum according to claim 1, wherein said adhesion affinity level is of at least 4000 CPM.

3. A chewing gum according to claim 1, comprising a gum base and an effective amount of at least one adhesion enhancing agent.

4. A chewing gum according to claim 3, wherein said adhesion enhancing agent comprises an edible acid.

5. A chewing gum according to claim 4, that would become organoleptically unacceptable if the amount of edible acids in the chewing gum were raised by 25% or more.

6. A chewing gum according to claim 4, wherein weight/weight ratio between edible acids and said gum base is at least 0.8 g acid: 60 g gum base.

7. A chewing gum according to claim 6, wherein said ratio is less than 1.8 g acid:60 g gum base.

8. A chewing gum according to claim 6, wherein said edible acid comprises at least one of citric, malic, fumaric, succinic, tartaric, sulfuric, and/or phosphoric acid.

9. A chewing gum according to claim 8, wherein the ratio between gum base and malic acid is of between 60:1.5 and 60:1.8.

10. A chewing gum according to claim 8, wherein the ratio between citric acid and gum base is at least 1 g acid per 60 g gum base.

11. A chewing gum according to claim 10, wherein said ratio is at most 1.8 g citric acid per 60 g gum base.

12. A chewing gum according to claim 1, wherein the adhesion inducing agent comprising a salt of an edible acid.

13. A chewing gum according to claim 12, wherein said salt is water-insoluble.

14. A chewing gum according to claim 13, wherein said salt is calcium citrate.

15. A chewing gum according to claim 14, comprising between 1.8 and 2.2 g calcium citrate per 60 g gum base.

16. A chewing gum according to claim 1, comprising only one artificial sweetener.

17. A chewing gum according to claim 1, wherein said adhesion enhancing agent comprising an edible coloring agent.

18. A chewing gum according to claim 17, wherein the coloring agent is carmoisine.

19. A chewing gum according to claim 17, wherein the coloring agent is selected from lycopene, carotene, and chlorophyll.

20. A chewing gum according claim 18, comprising between 1 and 50 mg carmoisine per 60 g gum base.

21. A chewing gum according to claim 18, comprising between 1 and 25 mg carmoisine per 60 g gum base.

22. A chewing gum according to claim 1 that is fruit-flavored.

23. A chewing gum according to claim 1, being free of sugar coating.

24. A chewing gum composition comprising gum base, polyols, calcium citrate, edible acid, fruit flavor, and carmoisine, wherein per 60 g gum base it includes 3-8 mg carmoisine and 1.6-2 g edible acid selected from citric acid, malic acid, and mixtures thereof.

25. A method for commercially producing and marketing chewing gums comprising
a. producing a batch of chewing gums;
b. checking at least one chewing gum of said batch for the extent at
which bacteria adhere to said at least one chewing gum; and marketing a batch of chewing gums responsive to the results of said checking. c.

26. A method according to claim 25, wherein said bacteria are plaque bacteria.

27. A method according to claim 25, wherein said extent is checked by a radioactive assay.

28. A method according to claim 25, wherein said extent is checked by a procedure comprising:
a. providing bacteria which carry markers;
b. contacting said marked bacteria with said at least one chewing gum;
c. rinsing said at least one chewing gum; and
d. determining the amount of markers that appear on said at least one chewing gums.

29. A method according to claim 28, wherein said markers are radioactive labels.

30. A chewing gum comprising at least the following components:
a. a gum base,
b. at least one edible acid, and
c. at least one of
i. salt of an edible acid and
ii. coloring agent,
the weight ratio between all said components being such that the chewing gum exhibits adhesion affinity level of at least 3000 CPM, while having acceptable organoleptic characteristics.

31. A method for preparing a chewing gum, comprising:
a. melting gum base;
b. mixing a coloring agent with polyol, in a ratio of at least 100 g polyol per 1 g carmoisin to obtain a mixture with homogeneous color; and
c. mixing the mixture obtained in (b) with the melt gum base.

32. A method according to claim 31, wherein said polyol is sorbitol.

33. A method according to claim 31, wherein said ratio is 250 g polyol to 1 g carmoisin.

34. A method according to claim 31, wherein the coloring agent is carmoisine.

35. A chewing gum according to claim 1, including no more than 3% w/w talc or talc replacement.

36. A chewing gum according to claim 1, which is sugar free.

37. A chewing gum according to claim 1, which is free of non-kosher ingredients.

38. An organoleptically acceptable sugar free chewing gum having an adhesion affinity level of above 3000 CPM, which is substantially free of at least one of the following: sugar coating, talc, Acesulfam-K, and Aspartame.

39. A chewing gum according to claim 1, comprising a gum base and at least one edible non-volatile acid, the weight ratio between all edible acids and gum base being such that the chewing gum exhibits adhesion affinity level of at least 3000 CPM.

40. A chewing gum according to claim 3, wherein said adhesion enhancing agent is free of polysaccharides.
